(19) United States
(12) Patent Application Publication
(10) Pub. No.: US 2026/0158871 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Hochan An, Hwaseong-si (KR); Yeon Ho Kim, Hwaseong-si (KR); Dong Jun Shim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(73) Assignees: HYUNDAI MOTOR COMPANY, Seoul (KR); KIA CORPORATION, Seoul (KR)

(21) Appl. No.: 19/236,378

(22) Filed: Jun. 12, 2025

(30) Foreign Application Priority Data
Dec. 6, 2024 (KR) 10-2024-0180993

(51) Int. Cl. B60H 1/32

(52) U.S. Cl. CPC B60H 1/3228

(57) ABSTRACT

A heat pump system for a vehicle, capable of improving cooling and heating performance, includes a gas injection device selectively operable in an air conditioning mode of the vehicle interior to increase the flow rate of the refrigerant. The heat pump system is capable of preventing the performance of cooling the vehicle interior from deteriorating, by preventing the temperature of the refrigerant discharged from the compressor from becoming excessively high, when the external temperature is high, or when a refrigerant having a high critical pressure and critical temperature is applied.

### CROSS-REFERENCE TO RELATED APPLICATION

This application claims priority to and the benefit of Korean Patent Application No. 10-2024-0180993 filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the cooling and heating performance thereof.

### Description of the Related Art

An air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by exchanging heat by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In an electric vehicle or a hybrid vehicle among these environment-friendly vehicles, a separate heater is not used unlike an air conditioner of a general vehicle, and an air conditioner used in an environment-friendly vehicle is generally called a heat pump system.

An electric vehicle driven by the power source of a fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system each should be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort of the vehicle.

In addition, for heating the vehicle interior, the heating performance may be deteriorated due to the lack of a heat source, the electricity consumption may be increased due to the usage of the electric heater, and the power consumption of the compressor may be increased.

The above information disclosed in this Background section is only for enhancement of understanding of the background of the disclosure, and therefore it may contain information that does not form the prior art that is already known to a person having ordinary skill in the art.

### SUMMARY OF THE DISCLOSURE

The present disclosure provides a heat pump system for a vehicle capable of improving cooling and heating performance by applying a gas injection device selectively operating in an air conditioning mode of the vehicle interior to increase the flow rate of the refrigerant.

In addition, according to the present disclosure, a heat pump system for a vehicle is capable of preventing deterioration of the performance of cooling the vehicle interior, by preventing the temperature of the refrigerant discharged from the compressor from becoming excessively high, when the external temperature is high, or when a refrigerant having a high critical pressure and critical temperature is applied.

A heat pump system for a vehicle includes a compressor configured to compress a refrigerant, a first heat-exchanger connected to the compressor through a refrigerant line, and a first expansion valve connected to the first heat-exchanger through the refrigerant line. The heat pump system further includes an evaporator connected to the first expansion valve through the refrigerant line, connected to the compressor through the refrigerant line, and configured to evaporate the supplied refrigerant. The heat pump system further includes a gas injection device provided on the refrigerant line between the first heat-exchanger and the first expansion valve, and configured to selectively expand the refrigerant supplied from the first heat-exchanger and allow the expanded refrigerant to flow. The gas injection device is further configured to selectively supply a partial refrigerant among the supplied refrigerant to the compressor to increase the flow rate of the refrigerant circulating in the refrigerant line, where a flowing movement of the refrigerant is controlled through an operation control of the gas injection device depending on at least one mode for adjusting a temperature of a vehicle interior.

The heat pump system may further include a connection line having a first end connected to the refrigerant line between the first heat-exchanger and the first expansion valve, and a second end connected to the refrigerant line between the compressor and the evaporator. The heat pump system may further include a chiller provided on the connection line, and configured to adjust a temperature of the coolant by exchanging heat with the refrigerant introduced through the connection line and a selectively introduced coolant. The heat pump system may further include a second expansion valve provided on the connection line at an upstream end of the chiller.

The gas injection device may include a gas-liquid separator provided on the refrigerant line between the first heat-exchanger and the first expansion valve. The gas injection device may include a third expansion valve provided on the refrigerant line at an upstream end of the gas-liquid separator. The gas injection device may further include a first line having a first end connected to the gas-liquid separator, and a second end connected to the compressor. The gas injection device may include a fourth expansion valve provided on the first line The gas injection device may include a second line having a first end connected to the fourth expansion valve, and a second end connected to the refrigerant line between the evaporator and the compressor.

The gas-liquid separator may be operated when the expanded refrigerant is supplied from the third expansion valve, and configured to supply a gaseous refrigerant among the supplied refrigerant to the compressor through the first line to increase the flow rate of the refrigerant circulating in the refrigerant line.

When an operation of the gas injection device is required, the third expansion valve may expand the refrigerant supplied through the refrigerant line, and may supply the expanded refrigerant to the gas-liquid separator.

In the at least one mode of the gas injection device, the fourth expansion valve may close a portion of the first line connected to the compressor, open the second line, and may expand the refrigerant introduced through the first line from the gas-liquid separator to allow the expanded refrigerant to flow to the second line.

In the at least one mode, the fourth expansion valve may close the second line, and may allow the refrigerant introduced through the first line from the gas-liquid separator to flow without expansion.

The at least one mode may include a first mode for cooling the vehicle interior and in which the gas injection device is operated, when the temperature of the refrigerant discharged from the compressor is greater than or equal to a critical temperature. The at least one mode may include a second mode for cooling the vehicle interior and in which the gas injection device is operated, when the temperature of the refrigerant discharged from the compressor is smaller than or equal to the critical temperature. The at least one mode may include a third mode for cooling a battery module while cooling the vehicle interior and in which the gas injection device is operated, when the temperature of the refrigerant discharged from the compressor is greater than or equal to the critical temperature. The at least one mode may include a fourth mode for heating the vehicle interior and in which the gas injection device is operated.

In the first mode, the refrigerant line interconnecting the compressor, the first heat-exchanger, the first expansion valve, and the evaporator may be opened. The connection line may be closed by the second expansion valve. A portion of the first line connecting the gas-liquid separator to the fourth expansion valve may be opened by the fourth expansion valve, and a remaining portion of the first line connecting the fourth expansion valve to the compressor may be closed by the fourth expansion valve. The second line may be opened by the fourth expansion valve. The first expansion valve may expand the refrigerant introduced through the refrigerant line and may supply the expanded refrigerant to the evaporator. The third expansion valve may expand the refrigerant introduced through the refrigerant line, and may supply the expanded refrigerant to the gas-liquid separator through the refrigerant line. The fourth expansion valve may expand the refrigerant introduced through the first line from the gas-liquid separator, and may allow the expanded refrigerant to flow along the second line. The gas-liquid separator may supply the gaseous refrigerant among the interiorly introduced refrigerant to the compressor through the opened portion of the first line and the second line.

In the second mode, the refrigerant line interconnecting the compressor, the first heat-exchanger, the first expansion valve, and the evaporator may be opened. The connection line may be closed by the second expansion valve. The first line may be opened by the fourth expansion valve, and the second line may be closed by the fourth expansion valve. The first expansion valve may expand the refrigerant introduced through the refrigerant line and may supply the expanded refrigerant to the evaporator. The third expansion valve may expand the refrigerant introduced through the refrigerant line, and may supply the expanded refrigerant to the gas-liquid separator through the refrigerant line. The fourth expansion valve may allow the refrigerant to flow without expansion introduced through the first line from the gas-liquid separator. The gas-liquid separator may supply the gaseous refrigerant among the interiorly introduced refrigerant to the compressor through the opened first line.

In the third mode, the refrigerant line interconnecting the compressor, the first heat-exchanger, the first expansion valve, and the evaporator may be opened. The connection line may be opened by the second expansion valve. a portion of the first line connecting the gas-liquid separator to the fourth expansion valve may be opened by the fourth expansion valve, and a remaining portion of the first line connecting the fourth expansion valve to the compressor may be closed by the fourth expansion valve. The second line may be opened by the fourth expansion valve. The first expansion valve may expand the refrigerant introduced through the refrigerant line and may supply the expanded refrigerant to the evaporator. The second expansion valve may expand the refrigerant introduced through the connection line and may supply the expanded refrigerant to the chiller. The third expansion valve may expand the refrigerant introduced through the refrigerant line, and may supply the expanded refrigerant to the gas-liquid separator through the refrigerant line. The fourth expansion valve may expand the refrigerant introduced through the first line from the gas-liquid separator, and may allow the expanded refrigerant to flow along the second line. The gas-liquid separator may supply the gaseous refrigerant among the interiorly introduced refrigerant to the compressor through the opened portion of the first line and the second line.

In the fourth mode, a portion of the refrigerant line connecting the compressor, the first heat-exchanger, and the gas injection device may be opened. A portion of the refrigerant line connecting the gas injection device to a first end of the connection line, and a portion of the refrigerant line connecting a second end of the connection line to the compressor, may be opened. A portion of the refrigerant line connecting the evaporator to the first end of the connection line, and a portion of the refrigerant line connecting the evaporator to the second end of the connection line, may be closed by the first expansion valve. The connection line may be opened by the second expansion valve. The first line may be opened by the fourth expansion valve. The second line may be closed by the fourth expansion valve. The second expansion valve may expand the refrigerant introduced through the connection line and may supply the expanded refrigerant to the chiller. The third expansion valve may expand the refrigerant introduced through the refrigerant line, and may supply the expanded refrigerant to the gas-liquid separator through the refrigerant line. The fourth expansion valve may allow the refrigerant introduced through the first line from the gas-liquid separator to flow without expansion. The gas-liquid separator may supply the gaseous refrigerant among the interiorly introduced refrigerant to the compressor through the opened first line.

The second expansion valve and the third expansion valve may be 2-way electronic expansion valves configured to selectively expand the refrigerant while controlling the flowing movement of the supplied refrigerant. The fourth expansion valve may be a 3-way electronic expansion valve configured to selectively expand the refrigerant while controlling the flowing movement of the refrigerant.

The heat pump system may further include a second heat-exchanger provided on the refrigerant line between the compressor and the first heat-exchanger, and an accumulator provided on the refrigerant line between the evaporator and the compressor.

The first heat-exchanger and the chiller may be water-cooled heat-exchangers configured to exchange heat between the interiorly introduced refrigerant with a coolant, and the second heat-exchanger may be an air-cooled heat-exchanger configured to exchange heat between the interiorly introduced refrigerant with air.

The heat pump system may further include an internal heat-exchanger connected to the refrigerant line connecting the first heat-exchanger and the first expansion valve and connected to the refrigerant line connecting the evaporator and the compressor, and configured to exchange heat between the refrigerant supplied from the first heat-exchanger and the refrigerant supplied from the evaporator.

The first heat-exchanger may be connected to an electrical component through a first coolant line through which a first coolant circulates, and a chiller may be connected to a battery module through a second coolant line along which a second coolant circulates.

As described above, according to a heat pump system for a vehicle according to an embodiment of the present disclosure, cooling and heating performance may be improved by applying a gas injection device selectively operating in an air conditioning mode of the vehicle interior to increase the flow rate of the refrigerant.

In addition, according to the present disclosure, when the external temperature is high, or when a refrigerant having a high critical pressure and critical temperature is applied, deterioration of the performance of cooling the vehicle interior may be prevented by preventing the temperature of the refrigerant discharged from the compressor from becoming excessively high.

In addition, according to the present disclosure, the performance of the system by using the gas injection device may be maximized while minimizing the required system components, and accordingly, streamlining and simplification of the system may be achieved.

In addition, according to the present disclosure, the power consumption of the compressor in the cooling mode of vehicle interior can be reduced, and the heating performance in the heating mode of the vehicle interior can be improved, thereby reducing the unnecessary power consumption, so that the overall travel distance of the vehicle may be increased.

In addition, according to the present disclosure, through streamlining of an entire system, it is possible to reduce manufacturing cost and weight and improve space utilization of a vehicle or a system for the vehicle.

### BRIEF DESCRIPTION OF THE DRAWINGS

FIG. 1 is a block diagram of a heat pump system for a vehicle according to an embodiment of the present disclosure.

FIG. 2 is an operation diagram according to a first mode of a heat pump system for a vehicle according to an embodiment of the present disclosure.

FIG. 3 is an operation diagram according to a second mode of a heat pump system for a vehicle according to an embodiment of the present disclosure.

FIG. 4 is an operation diagram according to a third mode of a heat pump system for a vehicle according to an embodiment of the present disclosure.

FIG. 5 is an operation diagram according to a fourth mode of a heat pump system for a vehicle according to an embodiment of the present disclosure.

### DETAILED DESCRIPTION

Embodiments of the present disclosure are hereinafter described in detail with reference to the accompanying drawings.

Embodiments disclosed in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of the application are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the words “comprise”, “have”, “include”, and variations thereof such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

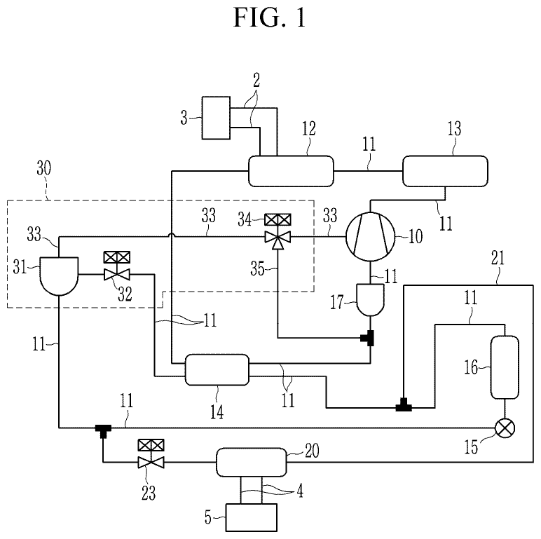

FIG. 1 is a block diagram of a heat pump system for a vehicle according to an embodiment of the present disclosure.

While cooling or heating of a vehicle interior, by increasing a flow rate of a refrigerant by applying a gas injection device 30 selectively operating in the selected air conditioning mode of the vehicle interior, a heat pump system for a vehicle according to an embodiment of the present disclosure may improve the cooling and heating performance of the vehicle.

In addition, when the external temperature is high, or when the refrigerant having a high critical pressure and critical temperature is applied, a heat pump system according to an embodiment of the present disclosure may prevent the temperature of the refrigerant discharged from a compressor 10 from becoming excessively high, thereby preventing deterioration of the performance of cooling the vehicle interior.

The refrigerant having the high critical pressure and critical temperature may be an R744 refrigerant.

The R744 refrigerant may be formed of carbon dioxide having an ozone depletion potential (ODP) of 0, and a global warming potential (GWP) of 1.

When the R744 refrigerant, which is a natural refrigerant using carbon dioxide, is applied, the heat pump system may operate in a supercritical cycle, in which the pressure and temperature of the refrigerant is higher than the critical pressure and temperature, so that the cooling and heating performance can be maximized.

Referring to FIG. 1, the heat pump system may include the compressor 10, a first heat-exchanger 12, a second heat-exchanger 13, an internal heat-exchanger 14, a first expansion valve 15, an evaporator 16, a chiller 20, a connection line 21, a second expansion valve 23, and the gas injection device 30.

The compressor 10 may compress the supplied refrigerant and allow the compressed refrigerant to flow along the refrigerant line 11 so that the refrigerant circulates along the refrigerant line 11.

The first heat-exchanger 12 may be connected to the compressor 10 through the refrigerant line 11. The first heat-exchanger 12 may condense the supplied refrigerant through exchanging heat with a coolant.

When the R744 refrigerant is applied, since the R744 refrigerant is a supercritical refrigerant and does not have a phase change unlike the typical refrigerant, the term “gas cooling” may be used instead of the term “condensation”.

The first heat-exchanger 12 may be connected to an electrical component 3 through a first coolant line 2 along which the coolant circulates. A water pump (not shown) may be provided on the first coolant line 2, and the coolant may be selectively circulated by an operation of the water pump to impart flow of the coolant through the coolant lines.

The electrical component 3 may include a power conversion device such as an electrical power control unit (EPCU), a motor, an inverter, an on-board charger (OBC), and/or an autonomous driving controller, or the like.

The electrical component 3 configured as such may be connected to the first coolant line 2 to be cooled in a water-cooled manner.

Accordingly, the first heat-exchanger 12 may adjust the temperature of the electrical component 3 by using the coolant heat-exchanged with the refrigerant, and may recollect a waste heat of the electrical component 3.

The second heat-exchanger 13 may be provided on, i.e., connected to or along, the refrigerant line 11 between the compressor 10 and the first heat-exchanger 12. The second heat-exchanger 13 may condense (or cool) the refrigerant through exchanging heat with the air.

In other words, the second heat-exchanger 13 may be an air-cooled heat-exchanger configured to exchange heat between the interiorly introduced refrigerant and the air.

In an embodiment of the present disclosure, the first expansion valve 15 may be connected to the first heat-exchanger 12 through the refrigerant line 11. The first expansion valve 15 may selectively expand the introduced refrigerant.

The evaporator 16 may be connected to the first expansion valve 15 through the refrigerant line 11. In addition, the evaporator 16 may be connected to the compressor 10 through the refrigerant line 11. The evaporator 16 may evaporate the refrigerant supplied from the first expansion valve 15 through exchanging heat with ambient air.

The evaporator 16 may be provided inside a Heating, Ventilation, and Air Conditioning (HVAC) module (not shown).

Accordingly, the air passing through the evaporator 16 may be cooled while passing through the evaporator 16 by a low-temperature refrigerant supplied to the evaporator 16. The cooled air may be introduced into the vehicle interior, thereby cooling the vehicle interior.

In other words, the evaporator 16 may be an air-cooled heat-exchanger configured to exchange heat between the interiorly introduced refrigerant and the air.

The internal heat-exchanger 14 may be respectively connected to the refrigerant line 11 connecting the first heat-exchanger 12 and the first expansion valve 15, and connected to the refrigerant line 11 connecting the evaporator 16 and the compressor 10.

The internal heat-exchanger 14 may exchange heat between the refrigerant supplied from the first heat-exchanger 12 and the refrigerant supplied from the evaporator 16.

In other words, the internal heat-exchanger 14 may exchange heat between the refrigerant condensed (or cooled) in the first heat-exchanger 12 and the low-temperature refrigerant discharged from the evaporator 16, and may respectively supply the heat-exchanged refrigerants to the compressor 10 and the evaporator 16.

The heat pump system may further include an accumulator 17.

The accumulator 17 may be provided on the refrigerant line 11 between the evaporator 16 and the compressor 10. In one example, the accumulator 17 may be provided on the refrigerant line 11 between the internal heat-exchanger 14 and the compressor 10.

The accumulator 17 may supply only a gaseous refrigerant to the compressor 10, thereby improving the efficiency and durability of the compressor 10.

In an embodiment of the present disclosure, the chiller 20 may be connected to a battery module 5 through a second coolant line 4 through which the coolant circulates. Accordingly, the coolant may selectively circulate through the chiller 20.

In other words, when the battery module 5 is to be cooled while cooling the vehicle interior, or when the waste heat of the battery module 5 is to be recollected at the time of heating the vehicle interior, the second coolant line 4 may be opened to connect the chiller 20 and the battery module 5.

The chiller 20 may adjust a temperature of the coolant by exchanging heat between the supplied refrigerant and the coolant.

In other words, the coolant heat-exchanged in the chiller 20 may circulate to the battery module 5 through the second coolant line 4. A water pump (not shown) may be provided on the second coolant line 4, and the coolant may be selectively circulated by the operation of the water pump.

The chiller 20 may adjust the temperature of the coolant selectively supplied through the second coolant line 4 by exchanging heat between the refrigerant supplied from the first heat-exchanger 12 by passing through the internal heat-exchanger 14 and the coolant.

In other words, the first heat-exchanger 12 and the chiller 20 may be a water-cooled heat-exchanger configured to exchange heat between the interiorly introduced refrigerant and the coolant.

The chiller 20 may be connected to the refrigerant line 11 through the connection line 21.

A first end of the connection line 21 may be connected to the refrigerant line 11 between the first heat-exchanger 12 and the first expansion valve 15.

In addition, a second end of the connection line 21 may be connected to the refrigerant line 11 between the evaporator 16 and the compressor 10. In one example, the second end of the connection line 21 may be connected to the refrigerant line 11 between the evaporator 16 and the internal heat-exchanger 14.

The chiller 20 may adjust the temperature of the coolant by exchanging heat between the coolant selectively introduced through the second coolant line 4 and the refrigerant selectively supplied from the first heat-exchanger 12.

Accordingly, the coolant heat-exchanged with the refrigerant in the chiller 20 may be selectively supplied to the battery module 5 to adjust the temperature of the battery module 5.

The chiller 20 configured as such may be disposed in parallel with the evaporator 16 through the connection line 21.

In an embodiment of the present disclosure, the second expansion valve 23 may be provided on the connection line 21 at an upstream end of the chiller 20, based on the flow direction of the refrigerant.

When the battery module 5 is to be cooled by using the coolant heat-exchanged with the refrigerant while cooling the vehicle interior, or when heating the vehicle interior, the second expansion valve 23 may expand the refrigerant introduced through the connection line 21 and allow the expanded refrigerant to flow into the chiller 20.

In other words, when the battery module 5 is to be cooled while cooling the vehicle interior, the second expansion valve 23 may expand the refrigerant introduced through the connection line 21 to lower its temperature and allow the expanded refrigerant to flow into chiller 20, and thereby may further lower the temperature of the coolant passing through the interior of the chiller 20.

Accordingly, the coolant having its temperature decreased while passing through the chiller 20 may be introduced into the battery module 5, thereby achieving more efficient cooling.

When the waste heat generated from the battery module 5 is to be recollected at the time of heating the vehicle interior, the second expansion valve 23 may expand the refrigerant introduced through the connection line 21, and may supply the expanded refrigerant to the chiller 20.

Accordingly, the chiller 20 may evaporate the refrigerant through exchanging heat with the coolant supplied through the second coolant line 4.

The chiller 20 may recollect the waste heat of the battery module 5 while exchanging heat between the refrigerant supplied from the second expansion valve 23 and the coolant supplied from the battery module 5.

The second expansion valve 23 configured as such may be a 2-way electronic expansion valve configured to selectively expand the refrigerant while controlling a flowing movement of the supplied refrigerant.

The upstream end of the chiller 20 may be set based on the flow direction of the refrigerant. Based on the direction in which the refrigerant flows along the connection line 21, the location where the refrigerant is introduced into the chiller 20 may be defined as an upstream end of the chiller 20, and the location where the refrigerant is discharged from the chiller 20 may be defined as a downstream end of the chiller 20.

In addition, the gas injection device 30 may be connected to the refrigerant line 11 between the first heat-exchanger 12 and the first expansion valve 15. In one example, the gas injection device 30 may be connected to the refrigerant line 11 between the internal heat-exchanger 14 and the first expansion valve 15.

The gas injection device 30 may selectively expand the refrigerant supplied from the first heat-exchanger 12 and allow the expanded refrigerant to flow, and may selectively supply a partial refrigerant among the supplied refrigerant to the compressor 10, to increase the flow rate of the refrigerant circulating within the refrigerant line 11.

The gas injection device 30 configured as such may be selectively operated at the time of cooling or heating the vehicle interior.

The gas injection device 30 may include a gas-liquid separator 31, a third expansion valve 32, a first line 33, a fourth expansion valve 34, and a second line 35.

The gas-liquid separator 31 may be provided on the refrigerant line 11 between the first heat-exchanger 12 and the first expansion valve 15.

The third expansion valve 32 may be provided on the refrigerant line 11 at an upstream end of the gas-liquid separator 31, based on the flow direction of the refrigerant.

When an operation of the gas injection device 30 is required, the third expansion valve 32 may expand the refrigerant supplied through the refrigerant line 11 after passing through the internal heat-exchanger 14 from the first heat-exchanger 12, and may supply the expanded refrigerant to the gas-liquid separator 31.

The third expansion valve 32 configured as such may be a 2-way electronic expansion valve configured to selectively expand the refrigerant while controlling the flowing movement of the refrigerant.

In an embodiment of the present disclosure, the upstream end of the gas-liquid separator 31 may be set based on the flow direction of the refrigerant. Based on the direction in which the refrigerant flows along the refrigerant line 11, the location where the refrigerant is introduced into the gas-liquid separator 31 may be defined as an upstream end of the gas-liquid separator 31, and the location where the refrigerant is discharged from the gas-liquid separator 31 may be defined as a downstream end of the gas-liquid separator 31.

In an embodiment of the present disclosure, a first end of the first line 33 may be connected to the gas-liquid separator 31. A second end of the first line 33 may be connected to the compressor 10.

In other words, the first line 33 may connect the gas-liquid separator 31 and the compressor 10 so that the gaseous refrigerant separated in the gas-liquid separator 31 is selectively introduced into the compressor 10.

The gas-liquid separator 31 may be operated when the expanded refrigerant is supplied from the third expansion valve 32.

The gas-liquid separator 31 may supply a gaseous refrigerant among the supplied refrigerant to the compressor 10 through the first line 33, to increase the flow rate of the refrigerant circulating the refrigerant line 11.

In an embodiment of the present disclosure, the fourth expansion valve 34 may be provided on the first line 33. The fourth expansion valve 34 may selectively expand the introduced refrigerant.

In addition, a first end of the second line 35 may be connected to the fourth expansion valve 34. A second end of the second line 35 may be connected to the refrigerant line 11 between the evaporator 16 and the compressor 10.

In other words, the fourth expansion valve 34 may be a 3-way electronic expansion valve configured to selectively expand the refrigerant while controlling the flowing movement of the refrigerant.

In at least one mode for adjusting a temperature of a vehicle interior, the fourth expansion valve 34 may close a portion of the first line 33 connected to the compressor 10 and may open the second line 35.

The fourth expansion valve 34 may expand the refrigerant introduced through the first line 33 from the gas-liquid separator 31 and allow the expanded refrigerant to flow to the second line 35.

In the gas injection device 30 configured as such, when the expanded refrigerant is supplied, the gas-liquid separator 31 may supply the gaseous refrigerant to the compressor 10 through the first line 33.

The gas-liquid separator 31 may discharge the liquid refrigerant to the refrigerant line 11.

In other words, when the expanded refrigerant is supplied to the gas-liquid separator 31, the gas-liquid separator 31 may supply the gaseous refrigerant among the supplied refrigerant to the compressor 10 through the first line 33 to increase the overall flow rate of the refrigerant circulating the refrigerant line 11.

In the heat pump system configured as such, the flowing movement of the refrigerant may be controlled through an operation control of the gas injection device 30 depending on at least one mode for adjusting the temperature of the vehicle interior.

The at least one mode may include a first mode, a second mode, a third mode, and a fourth mode.

In the first mode, when the temperature of the refrigerant discharged from the compressor 10 is greater than or equal to the critical temperature, the gas injection device 30 may be operated and the vehicle interior may be cooled.

In the second mode, when the temperature of the refrigerant discharged from the compressor 10 is smaller than or equal to the critical temperature, the gas injection device 30 may be operated and the vehicle interior may be cooled.

In the third mode, when the temperature of the refrigerant discharged from the compressor 10 is greater than or equal to the critical temperature, the gas injection device 30 may be operated, and the battery module 5 may be cooled while cooling the vehicle interior.

In addition, in the fourth mode, the gas injection device 30 may be operated, and the vehicle interior may be heated.

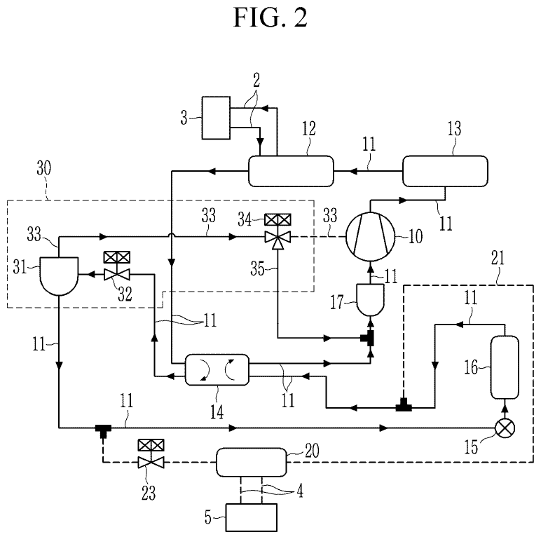

Hereinafter, an operation and action of a heat pump system for a vehicle according to an embodiment of the present disclosure configured as described above is described in detail with reference to FIGS. 2-5.

An operation in the first mode for cooling the vehicle interior and in which the gas injection device 30 is operated, when the temperature of the refrigerant discharged from the compressor 10 is greater than or equal to the critical temperature, is described in detail below with reference to FIG. 2.

FIG. 2 is an operation diagram according to the first mode of a heat pump system for a vehicle according to an embodiment of the present disclosure.

Referring to FIG. 2, in the first mode, the refrigerant line 11 interconnecting the compressor 10, the first heat-exchanger 12, the first expansion valve 15, and the evaporator 16 may be opened.

The connection line 21 may be closed by the second expansion valve 23.

In an embodiment of the present disclosure, a portion of the first line 33 connecting the gas-liquid separator 31 to the fourth expansion valve 34 may be opened by the fourth expansion valve 34.

In addition, a remaining portion of the first line 33 connecting the fourth expansion valve 34 to the compressor 10 may be closed by the fourth expansion valve 34.

In addition, the second line 35 may be opened by the fourth expansion valve 34.

In such a state, the refrigerant compressed in the compressor 10 may be introduced into the second heat-exchanger 13 and the first heat-exchanger 12 along the refrigerant line 11. The first coolant line 2 may be opened so that the coolant is supplied to the electrical component 3.

Accordingly, the second heat-exchanger 13 may condense (or cool) the refrigerant by using the air introduced from the outside while the vehicle is driving. The first heat-exchanger 12 may condense (or cool) the refrigerant by using the coolant supplied from the electrical component 3.

The refrigerant condensed (or cooled) in the first heat-exchanger 12 may be introduced into the internal heat-exchanger 14 along the refrigerant line 11. Thereafter, the refrigerant having passed through the internal heat-exchanger 14 may be introduced into the third expansion valve 32.

The third expansion valve 32 may expand the refrigerant introduced through the refrigerant line 11, and may supply the expanded refrigerant to the gas-liquid separator 31 through the refrigerant line 11.

The gas-liquid separator 31 may supply the gaseous refrigerant among the interiorly introduced refrigerant to the fourth expansion valve 34 through the first line 33.

The fourth expansion valve 34 may expand the refrigerant introduced through the first line 33 from the gas-liquid separator 31, and may allow the expanded refrigerant to flow along the second line 35.

Accordingly, the refrigerant discharged from the gas-liquid separator 31 to the first line 33 may have a lower pressure and lower temperature while being expanded in the fourth expansion valve 34. The refrigerant having the lowered pressure and temperature may flow along the second line 35.

In other words, the gas-liquid separator 31 may supply the gaseous refrigerant among the interiorly introduced refrigerant to the compressor 10 through the opened portion of the first line 33 and the second line 35.

The refrigerant flowing through the second line 35 may be introduced into the compressor 10 via the accumulator 17 together with the refrigerant flowing through the refrigerant line 11 connected to the compressor 10 to increase the flow rate of the refrigerant circulating the refrigerant line 11.

Since the refrigerant having its pressure and temperature lowered while passing through the fourth expansion valve 34 is introduced into the compressor 10 together with the refrigerant flowing through the refrigerant line 11, the overall temperature of the refrigerant discharged from the compressor 10 may be lowered.

In other words, by such an operation, the gas injection device 30 may increase the flow rate of the refrigerant circulating through the refrigerant line 11, and lower the temperature of the refrigerant discharged from the compressor 10, so that deterioration of the performance of cooling the vehicle interior may be prevented due to the degradation of the operation performance of the compressor 10.

The gas-liquid separator 31 may supply the liquid refrigerant among the interiorly introduced refrigerant to the first expansion valve 15 through the refrigerant line 11.

The first expansion valve 15 may expand the refrigerant introduced through the refrigerant line 11 and supply the expanded refrigerant to the evaporator 16.

In such a state, the ambient air introduced into an HVAC module (not shown) may be cooled by the low-temperature refrigerant introduced into the evaporator 16 while passing through the evaporator 16. The cooled ambient air may cool the vehicle interior by being directly introduced into the vehicle interior.

In addition, the refrigerant having passed through the evaporator 16 may be introduced into the internal heat-exchanger 14 along the refrigerant line 11.

The internal heat-exchanger 14 may exchange heat between the refrigerant supplied from the first heat-exchanger 12 and the refrigerant supplied from the evaporator 16.

In other words, the internal heat-exchanger 14 may exchange heat between the refrigerant condensed (or cooled) in the first heat-exchanger 12 and the low-temperature refrigerant discharged from the evaporator 16, and may respectively supply the heat-exchanged refrigerants to the compressor 10 and the third expansion valve 32.

In addition, the refrigerant from the evaporator 16 having passed through the internal heat-exchanger 14 may be introduced into the accumulator 17 along the refrigerant line 11 together with the refrigerant flowing through the refrigerant line 11, through the second line 35. Thereafter, the refrigerant may pass through the accumulator 17 to be introduced into the compressor 10.

The refrigerant compressed in the compressor 10 may pass through the second heat-exchanger 13 along the refrigerant line 11 to be then supplied to the first heat-exchanger 12.

The heat pump system may repeatedly perform the above-described processes.

While repeatedly performing the above-described operation, the heat pump system may increase the flow rate of the refrigerant flowing along the refrigerant line 11, and may lower the temperature of the refrigerant additionally supplied to the compressor 10 through an operation control of the gas injection device 30.

Accordingly, when the temperature of the refrigerant discharged from the compressor 10 is greater than or equal to the critical temperature, the heat pump system can lower the temperature of the refrigerant discharged from the compressor 10, thereby maintaining the operating performance of the compressor 10, and preventing the performance of cooling the vehicle interior from deteriorating.

In addition, the heat pump system may increase the flow rate of the refrigerant flowing along the refrigerant line 11, thereby improving the overall cooling performance and efficiency of the system.

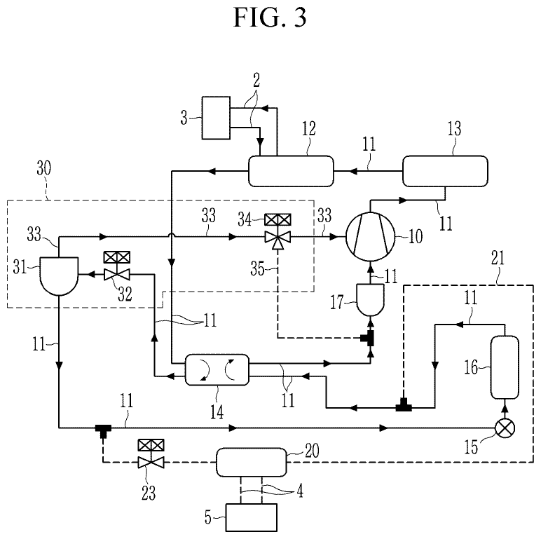

In an embodiment of the present disclosure, an operation in the second mode for cooling the vehicle interior and in which the gas injection device 30 is operated, when the temperature of the refrigerant discharged from the compressor 10 is smaller than or equal to the critical temperature, is described in detail below with reference to FIG. 3.

FIG. 3 is an operation diagram according to the second mode of a heat pump system for a vehicle according to an embodiment of the present disclosure.

Referring to FIG. 3, in the second mode, the refrigerant line 11 interconnecting the compressor 10, the first heat-exchanger 12, the first expansion valve 15, and the evaporator 16 may be opened.

The connection line 21 may be closed by the second expansion valve 23.

In an embodiment of the present disclosure, the first line 33 may be opened by the fourth expansion valve 34.

The second line 35 may be closed by the fourth expansion valve 34.

In such a state, the refrigerant compressed in the compressor 10 may be introduced into the second heat-exchanger 13 and the first heat-exchanger 12 along the refrigerant line 11. The first coolant line 2 may be opened so that the coolant is supplied to the electrical component 3.

Accordingly, the second heat-exchanger 13 may condense (or cool) the refrigerant by using the air introduced from the outside while the vehicle is driving. The first heat-exchanger 12 may condense (or cool) the refrigerant by using the coolant supplied from the electrical component 3.

The refrigerant condensed (or cooled) in the first heat-exchanger 12 may be introduced into the internal heat-exchanger 14 along the refrigerant line 11. Thereafter, the refrigerant having passed through the internal heat-exchanger 14 may be introduced into the third expansion valve 32.

The third expansion valve 32 may expand the refrigerant introduced through the refrigerant line 11, and may supply the expanded refrigerant to the gas-liquid separator 31 through the refrigerant line 11.

The gas-liquid separator 31 may supply the gaseous refrigerant among the interiorly introduced refrigerant to the fourth expansion valve 34 through the first line 33.

The fourth expansion valve 34 may allow the refrigerant introduced through the first line 33 from the gas-liquid separator 31 to flow without expansion.

Accordingly, the refrigerant discharged from the gas-liquid separator 31 may be supplied to the compressor 10 through the first line 33 without expansion.

In other words, the gas-liquid separator 31 may supply the gaseous refrigerant among the interiorly introduced refrigerant to the compressor 10 through the opened first line 33.

Through such an operation, the gas injection device 30 may allow the gaseous refrigerant discharged from the gas-liquid separator 31 to flow back to the compressor 10 through the first line 33, to increase the flow rate of the refrigerant circulating the refrigerant line 11.

The gas-liquid separator 31 may supply the liquid refrigerant among the interiorly introduced refrigerant to the first expansion valve 15 through the refrigerant line 11.

The first expansion valve 15 may expand the refrigerant introduced through the refrigerant line 11 and supply the expanded refrigerant to the evaporator 16.

In such a state, the ambient air introduced into an HVAC module (not shown) may be cooled by the low-temperature refrigerant introduced into the evaporator 16 while passing through the evaporator 16. The cooled ambient air may cool the vehicle interior by being directly introduced into the vehicle interior.

In addition, the refrigerant having passed through the evaporator 16 may be introduced into the internal heat-exchanger 14 along the refrigerant line 11.

The internal heat-exchanger 14 may exchange heat between the refrigerant supplied from the first heat-exchanger 12 and the refrigerant supplied from the evaporator 16.

In other words, the internal heat-exchanger 14 may exchange heat between the refrigerant condensed (or cooled) in the first heat-exchanger 12 and the low-temperature refrigerant discharged from the evaporator 16, and may respectively supply the heat-exchanged refrigerants to the compressor 10 and the third expansion valve 32.

In addition, the refrigerant from the evaporator 16 having passed through the internal heat-exchanger 14 may be introduced into the accumulator 17 along the refrigerant line 11. Thereafter, the refrigerant may pass through the accumulator 17 to be introduced into the compressor 10.

In other words, the refrigerant having passed through the accumulator 17, and the refrigerant supplied from the gas-liquid separator 31 through the first line 33, may be introduced into the compressor 10. The introduced refrigerant may be compressed by the compressor 10.

The refrigerant compressed in the compressor 10 may pass through the second heat-exchanger 13 along the refrigerant line 11 to be then supplied to the first heat-exchanger 12.

The heat pump system may repeatedly perform the above-described processes.

While repeatedly performing the above-described operation, the heat pump system may increase the flow rate of the refrigerant flowing along the refrigerant line 11.

In addition, the internal heat-exchanger 14 may exchange heat between the refrigerant condensed (or cooled) in the first heat-exchanger 12 and the refrigerant introduced from the evaporator 16, thereby further increasing the condensation degree (or cooling level) of the refrigerant.

As such, since the gas injection device 30 injects the refrigerant having an increased condensation degree through the control of the flowing movement of the refrigerant, a subcooling degree of the refrigerant discharged from the first heat-exchanger 12 may be increased.

When the subcooling degree of the refrigerant discharged from the first heat-exchanger 12 is increased, the evaporator 16 may have a significantly large level of the enthalpy difference, and the cooling load can be minimized.

Accordingly, when the temperature of the refrigerant discharged from the compressor 10 is smaller than or equal to the critical temperature, the heat pump system may more efficiently cool the vehicle interior by controlling the flowing movement of the refrigerant discharged from the first heat-exchanger 12 through an operation control of the gas injection device 30.

In addition, the heat pump system may increase the flow rate of the refrigerant flowing along the refrigerant line 11, thereby improving the overall cooling performance and efficiency of the system.

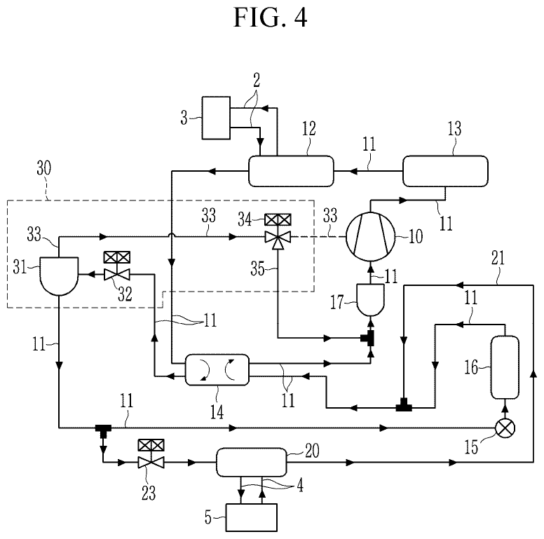

In an embodiment of the present disclosure, an operation in the third mode for cooling the battery module 5 while cooling the vehicle interior and in which the gas injection device 30 is operated, when the temperature of the refrigerant discharged from the compressor 10 is greater than or equal to the critical temperature, is described in detail below with reference to FIG. 4.

FIG. 4 is an operation diagram according to the third mode of a heat pump system for a vehicle according to an embodiment of the present disclosure.

Referring to FIG. 4, in the third mode, the refrigerant line 11 interconnecting the compressor 10, the first heat-exchanger 12, the first expansion valve 15, and the evaporator 16 may be opened.

The connection line 21 may be opened by the second expansion valve 23.

In an embodiment of the present disclosure, a portion of the first line 33 connecting the gas-liquid separator 31 to the fourth expansion valve 34 may be opened by the fourth expansion valve 34.

In addition, a remaining portion of the first line 33 connecting the fourth expansion valve 34 to the compressor 10 may be closed by the fourth expansion valve 34.

In addition, the second line 35 may be opened by the fourth expansion valve 34.

In such a state, the refrigerant compressed in the compressor 10 may be introduced into the second heat-exchanger 13 and the first heat-exchanger 12 along the refrigerant line 11. The first coolant line 2 may be opened so that the coolant is supplied to the electrical component 3.

Accordingly, the second heat-exchanger 13 may condense (or cool) the refrigerant by using the air introduced from the outside while the vehicle is driving. The first heat-exchanger 12 may condense (or cool) the refrigerant by using the coolant supplied from the electrical component 3.

The refrigerant condensed (or cooled) in the first heat-exchanger 12 may be introduced into the internal heat-exchanger 14 along the refrigerant line 11. Thereafter, the refrigerant having passed through the internal heat-exchanger 14 may be introduced into the third expansion valve 32.

The third expansion valve 32 may expand the refrigerant introduced through the refrigerant line 11, and may supply the expanded refrigerant to the gas-liquid separator 31 through the refrigerant line 11.

The gas-liquid separator 31 may supply the gaseous refrigerant among the interiorly introduced refrigerant to the fourth expansion valve 34 through the first line 33.

The fourth expansion valve 34 may expand the refrigerant introduced through the first line 33 from the gas-liquid separator 31, and may allow the expanded refrigerant to flow along the second line 35.

Accordingly, the refrigerant discharged from the gas-liquid separator 31 to the first line 33 may have a lower pressure and a lower temperature while being expanded in the fourth expansion valve 34. The refrigerant having the lowered pressure and temperature may flow along the second line 35.

In other words, the gas-liquid separator 31 may supply the gaseous refrigerant among the interiorly introduced refrigerant to the compressor 10 through the opened portion of the first line 33 and the second line 35.

The refrigerant flowing through the second line 35 may be introduced into the compressor 10 via the accumulator 17 together with the refrigerant flowing through the refrigerant line 11 connected to the compressor 10, to increase the flow rate of the refrigerant circulating the refrigerant line 11.

Since the refrigerant having the pressure and temperature lowered while passing through the fourth expansion valve 34 is introduced into the compressor 10 together with the refrigerant flowing through the refrigerant line 11, the overall temperature of the refrigerant discharged from the compressor 10 may be lowered.

In other words, by such an operation, the gas injection device 30 may increase the flow rate of the refrigerant circulating through the refrigerant line 11, and may lower the temperature of the refrigerant discharged from the compressor 10, so that the performance of cooling the vehicle interior may be prevented from deteriorating due to the degradation of the operation performance of the compressor 10.

The refrigerant discharged from the gas-liquid separator 31 through the refrigerant line 11 may be respectively introduced into the first expansion valve 15 and the second expansion valve 23 along the refrigerant line 11 and the connection line 21.

The first expansion valve 15 may expand the refrigerant introduced through the refrigerant line 11 and supply the expanded refrigerant to the evaporator 16.

In such a state, the ambient air introduced into an HVAC module (not shown) may be cooled by the low-temperature refrigerant introduced into the evaporator 16 while passing through the evaporator 16. The cooled ambient air may cool the vehicle interior by being directly introduced into the vehicle interior.

The second expansion valve 23 may expand the refrigerant introduced through the connection line 21 and supply the expanded refrigerant to the chiller 20.

The refrigerant introduced into the chiller 20 may cool the coolant while exchanging heat with the coolant supplied from the battery module 5 through the second coolant line 4.

The coolant cooled in the chiller 20 may be supplied to the battery module 5 along the second coolant line 4. Accordingly, the battery module 5 may be efficiently cooled by the coolant cooled in the chiller 20.

In other words, the coolant circulating through the second coolant line 4 may efficiently cool the battery module 5 while repeatedly performing the above-described operation.

In addition, the refrigerant having respectively passed through the evaporator 16 and the chiller 20 may be introduced into the internal heat-exchanger 14 along the refrigerant line 11.

The internal heat-exchanger 14 may exchange heat between the refrigerant supplied from the first heat-exchanger 12 and the refrigerant supplied from the evaporator 16.

In other words, the internal heat-exchanger 14 may exchange heat between the refrigerant condensed (or cooled) in the first heat-exchanger 12 and the low-temperature refrigerant respectively discharged from the evaporator 16 and the chiller 20, and may respectively supply the heat-exchanged refrigerants to the compressor 10 and the third expansion valve 32.

In addition, the refrigerant from the evaporator 16 having passed through the internal heat-exchanger 14 may be introduced into the accumulator 17 along the refrigerant line 11 together with the refrigerant flowing through the refrigerant line 11, through the second line 35. Thereafter, the refrigerant may pass through the accumulator 17 to be introduced into the compressor 10.

The refrigerant compressed in the compressor 10 may pass through the second heat-exchanger 13 along the refrigerant line 11 to be then supplied to the first heat-exchanger 12.

The heat pump system may repeatedly perform the above-described processes.

While repeatedly performing the above-described operation, the heat pump system may increase the flow rate of the refrigerant flowing along the refrigerant line 11, and may lower the temperature of the refrigerant additionally supplied to the compressor 10 through the operation control of the gas injection device 30.

Accordingly, when the temperature of the refrigerant discharged from the compressor 10 is greater than or equal to the critical temperature, the heat pump system can lower the temperature of the refrigerant discharged from the compressor 10, thereby maintaining the operating performance of the compressor 10, and preventing the performance of cooling the vehicle interior from deteriorating.

In addition, the heat pump system may increase the flow rate of the refrigerant flowing along the refrigerant line 11, thereby improving the overall cooling performance and efficiency of the system.

The heat pump system may efficiently cool the battery module 5 by using a low-temperature coolant cooled in the chiller 20.

In an embodiment of the present disclosure, when the temperature of the refrigerant discharged from the compressor 10 is greater than or equal to the critical temperature, the gas injection device 30 is operated and the battery module 5 is cooled while cooling the vehicle interior. However, the present disclosure is not limited thereto.

When the temperature of the refrigerant discharged from the compressor 10 is smaller than or equal to the critical temperature, in the heat pump system, the gas injection device 30 may be operated, and the battery module 5 may be cooled together while cooling the vehicle interior.

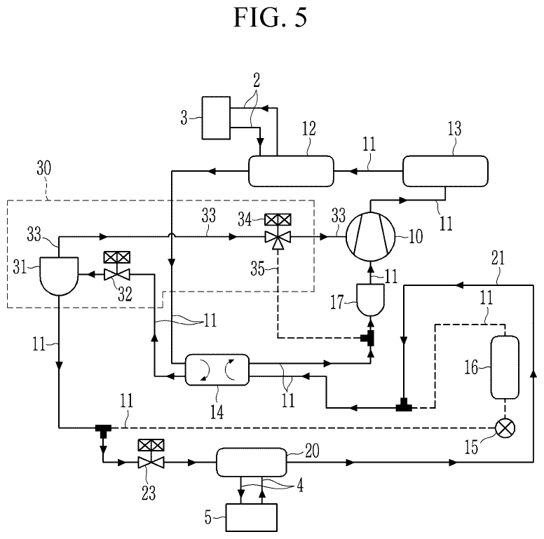

In addition, the fourth mode for heating the vehicle interior and in which the gas injection device is operated is described in detail below with reference to FIG. 5.

FIG. 5 is an operation diagram according to the fourth mode of a heat pump system for a vehicle according to an embodiment of the present disclosure.

Referring to FIG. 5, in the fourth mode, a portion of the refrigerant line 11 connecting the compressor 10, the first heat-exchanger 12, and the gas injection device 30 may be opened.

In addition, the portion of the refrigerant line 11 connecting the gas injection device 30 to the first end of the connection line 21, and the portion of the refrigerant line 11 connecting the second end of the connection line 21 to the compressor 10, may be opened.

In other words, the portion of the refrigerant line 11 connecting the first end of the connection line 21 to the second end of the connection line 21 via the first expansion valve 15 and the evaporator 16 may be closed by the first expansion valve 15.

In an embodiment of the present disclosure, the connection line 21 may be opened by the second expansion valve 23.

The first line 33 may be opened by the fourth expansion valve 34. In addition, the second line 35 may be closed by the fourth expansion valve 34.

In such a state, the refrigerant compressed in the compressor 10 may be introduced into the second heat-exchanger 13 and the first heat-exchanger 12 along the refrigerant line 11. The first coolant line 2 may be opened so that the coolant is supplied to the electrical component 3.

Accordingly, the second heat-exchanger 13 may condense (or cool) the refrigerant by using the air introduced from the outside while the vehicle is driving. The first heat-exchanger 12 may condense (or cool) the refrigerant by using the coolant supplied from the electrical component 3.

The refrigerant may recollect an ambient air heat through exchanging heat with the ambient air while passing through the second heat-exchanger 13. In addition, the refrigerant may recollect the waste heat of the electrical component 3 through exchanging heat with the coolant while passing through the first heat-exchanger 12.

In other words, the first heat-exchanger 12 and the second heat-exchanger 13 may recollect the ambient air heat and the waste heat of the electrical component 3 through the above-described operation, and use it to increase the temperature of the refrigerant.

The refrigerant condensed (or cooled) in the first heat-exchanger 12 may be introduced into the internal heat-exchanger 14 along the refrigerant line 11. Thereafter, the refrigerant having passed through the internal heat-exchanger 14 may be introduced into the third expansion valve 32.

The third expansion valve 32 may expand the refrigerant introduced through the refrigerant line 11, and may supply the expanded refrigerant to the gas-liquid separator 31 through the refrigerant line 11.

The fourth expansion valve 34 may allow the refrigerant introduced through the first line 33 from the gas-liquid separator 31 to flow without expansion.

Accordingly, the refrigerant discharged from the gas-liquid separator 31 may be supplied to the compressor 10 through the first line 33 without expansion.

In other words, the gas-liquid separator 31 may supply the gaseous refrigerant among the interiorly introduced refrigerant to the compressor 10 through the opened first line 33.

Through such an operation, the gas injection device 30 may allow the gaseous refrigerant discharged from the gas-liquid separator 31 to flow back to the compressor 10 through the first line 33 to increase the flow rate of the refrigerant circulating the refrigerant line 11.

The refrigerant discharged from the gas-liquid separator 31 through the refrigerant line 11 may be introduced into the second expansion valve 23 along the connection line 21.

The second expansion valve 23 may expand the refrigerant introduced through the connection line 21 and supply the expanded refrigerant to the chiller 20.

In this case, the second coolant line 4 may be opened to connect the chiller 20 and the battery module 5.

Accordingly, the refrigerant introduced into the chiller 20 may cool the coolant while exchanging heat with the coolant supplied from the battery module 5 through the second coolant line 4.

The temperature of the coolant circulating along the second coolant line 4 may be increased by absorbing the waste heat from the battery module 5.

In such a state, the coolant may be supplied to the chiller 20 along the second coolant line 4. Therefore, the waste heat generated from the battery module 5 may increase the temperature of the refrigerant supplied to the chiller 20.

In other words, the chiller 20 may recollect the waste heat of the battery module 5 through exchanging heat between the coolant and the refrigerant, and use it to increase the temperature of the refrigerant.

The refrigerant having passed through the chiller 20 may be introduced into the internal heat-exchanger 14 along the refrigerant line 11.

The internal heat-exchanger 14 may exchange heat between the refrigerant supplied from the first heat-exchanger 12 and the refrigerant supplied from the evaporator 16.

In other words, the internal heat-exchanger 14 may exchange heat between the refrigerant condensed (or cooled) in the first heat-exchanger 12 and the low-temperature refrigerant respectively discharged from the evaporator 16 and the chiller 20, and may respectively supply the heat-exchanged refrigerants to the compressor 10 and the third expansion valve 32.

In addition, the refrigerant from the chiller 20 having passed through the internal heat-exchanger 14 may be introduced into the accumulator 17 along the refrigerant line 11. Thereafter, the refrigerant may pass through the accumulator 17, to be introduced into the compressor 10.

The refrigerant compressed in the compressor 10 may pass through the second heat-exchanger 13 along the refrigerant line 11 to be supplied to the first heat-exchanger 12.

The heat pump system may repeatedly perform the above-described processes.

Although not shown in the drawings, the first heat-exchanger 12 in the heat pump system may be connected to a heating device for heating the vehicle interior through a separate coolant line (not shown).

The heating device may be provided inside an HVAC module (not shown),

### Together With the Evaporator 16.

Accordingly, the refrigerant introduced into the first heat-exchanger 12 may exchange heat with the coolant supplied from the heating device. The coolant, having its heat increased through exchanging heat with the refrigerant in the first heat-exchanger 12, may be supplied to the heating device.

The ambient air introduced into the vehicle interior may be converted into a high-temperature state through exchanging heat with the high-temperature coolant introduced into the heating device and introduced into the vehicle interior, thereby achieving heating of the vehicle interior.

When the first heat-exchanger 12 is not connected to the heating device, the second heat-exchanger 13 in the heat pump system may be provided inside an HVAC module (not shown), together with the evaporator 16.

Accordingly, the ambient air introduced into the vehicle interior may be converted into a high-temperature state through exchanging heat with a high-temperature refrigerant introduced into the second heat-exchanger 13 and introduced into the vehicle interior, thereby achieving heating of the vehicle interior.

Accordingly, the refrigerant circulated in the heat pump system can smoothly recollect the ambient air heat, or the waste heat of the electrical component 3, or the waste heat of the battery module 5, thereby improving the overall heating performance and efficiency of the system.

In addition, according to the present disclosure, the heating efficiency and performance may be improved while minimizing the usage of a separate electric

### Heater.

In other words, while repeatedly performing the above-described operation, the heat pump system may increase the flow rate of the refrigerant flowing along the refrigerant line 11, and may sufficiently recollect and use the waste heat, thereby improving the heating performance and efficiency of the system.

In addition, the gas injection device 30 may increase the flow rate of the refrigerant circulating the refrigerant line 11, thereby maximizing the heating performance.

Therefore, as described above, by using the single chiller 20 where the coolant and the refrigerant exchange heat with each other, a heat pump system for a vehicle according to an embodiment of the present disclosure may recollect the waste heat of the battery module 5 or cool the battery module 5 depending on the air conditioning mode of the vehicle interior, and may adjust the temperature of the battery module 5.

In addition, according to the present disclosure, by increasing the flow rate of the refrigerant by applying the gas injection device 30 selectively operating in the selected air conditioning mode of the vehicle interior, the cooling and heating performance of the system may be improved.

In addition, according to the present disclosure, by preventing the temperature of the refrigerant discharged from the compressor 10 from becoming excessively high, when the external temperature is high, or when the refrigerant having the pressure and temperature higher than the critical pressure and temperature, the performance of cooling the vehicle interior can be prevented from deteriorating.

In addition, according to the present disclosure, the performance of the system can be maximized by using the gas injection device 30, while minimizing the number of system components, so that streamlining and simplification of the system may be achieved.

In addition, according to the present disclosure, the power consumption of the compressor 10 may be reduced in a cooling mode of the vehicle interior, and the unnecessary power consumption may be reduced by improving the heating performance in a heating mode of the vehicle interior, so that the overall travel distance of the vehicle may be increased.

In addition, according to the present disclosure, through streamlining of an entire system, it is possible to reduce manufacturing cost and weight and improve space utilization of a vehicle and a system for the vehicle.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2, 4: first and second coolant lines
3: electrical component
5: battery module
10: compressor
11: refrigerant line
12: first heat-exchanger
13: second heat-exchanger
14: internal heat-exchanger
15: first expansion valve
16: evaporator
17: accumulator
20: chiller
21: connection line
23: second expansion valve
30: gas injection device
31: gas-liquid separator
32: third expansion valve
33: first line
34: fourth expansion valve
35: second line

What is claimed is:

1. A heat pump system for a vehicle, the heat pump system comprising:
a compressor configured to compress a refrigerant;
a first heat-exchanger connected to the compressor through a refrigerant line;
a first expansion valve connected to the first heat-exchanger through the refrigerant line;
an evaporator connected to the first expansion valve through the refrigerant line and connected to the compressor through the refrigerant line, the evaporator configured to evaporate the refrigerant;
a gas injection device provided on the refrigerant line between the first heat-exchanger and the first expansion valve, the gas injection device configured to selectively expand the refrigerant supplied from the first heat-exchanger and allow the refrigerant expanded by the gas injection device to flow, and selectively supply a partial refrigerant among the refrigerant to the compressor to increase the flow rate of the refrigerant circulating through the refrigerant line,
wherein a flowing movement of the refrigerant is controlled through operation of the gas injection device based on at least one mode for controlling a temperature of a vehicle interior.

2. The heat pump system of claim 1, further comprising:
a connection line including
a first end connected to the refrigerant line between the first heat-exchanger and the first expansion valve, and
a second end connected to the refrigerant line between the compressor and the evaporator;
a chiller provided on the connection line, the chiller configured to adjust a temperature of a coolant by exchanging heat between the refrigerant introduced through the connection line and the coolant; and
a second expansion valve provided on the connection line at an upstream end of the chiller.

3. The heat pump system of claim 2, wherein the gas injection device comprises:
a gas-liquid separator provided on the refrigerant line between the first heat-exchanger and the first expansion valve;
a third expansion valve provided on the refrigerant line at an upstream end of the gas-liquid separator;
a first line having a first end connected to the gas-liquid separator, and a second end connected to the compressor;
a fourth expansion valve provided on the first line; and
a second line having a first end connected to the fourth expansion valve, and a second end connected to the refrigerant line between the evaporator and the compressor.

4. The heat pump system of claim 3, wherein the gas-liquid separator is configured to operate when the refrigerant expanded by the third expansion valve is supplied to the gas-liquid separator, and wherein the gas-liquid separator is further configured to supply a gaseous refrigerant among the refrigerant to the compressor through the first line, to increase the flow rate of the refrigerant circulating through the refrigerant line.

5. The heat pump system of claim 3, wherein, when an operation of the gas injection device is required, the third expansion valve is configured to expand the refrigerant supplied through the refrigerant line, and is configured to supply the refrigerant expanded by the third expansion valve to the gas-liquid separator.

6. The heat pump system of claim 3, wherein, in the at least one mode, the fourth expansion valve is configured to close a portion of the first line connected to the compressor, the fourth expansion valve is configured to open the second line, and the fourth expansion valve is configured to expand the refrigerant introduced through the first line from the gas-liquid separator to allow the refrigerant expanded by the fourth expansion valve to flow to the second line.

7. The heat pump system of claim 3, wherein, in the at least one mode, the fourth expansion valve is configured to close the second line, and the fourth expansion valve is further configured to allow the refrigerant introduced through the first line from the gas-liquid separator to flow without expansion.

8. The heat pump system of claim 3, wherein the at least one mode comprises:
a first mode for cooling the vehicle interior and in which the gas injection device is configured to be operated when the temperature of the refrigerant discharged from the compressor is greater than or equal to a critical temperature;
a second mode for cooling the vehicle interior and in which the gas injection device is configured to be operated when the temperature of the refrigerant discharged from the compressor is smaller than or equal to the critical temperature;
a third mode for cooling a battery module while cooling the vehicle interior and in which the gas injection device is configured to be operated when the temperature of the refrigerant discharged from the compressor is greater than or equal to the critical temperature; and
a fourth mode for heating the vehicle interior and in which the gas injection device is configured to be operated.

9. The heat pump system of claim 8, wherein, in the first mode:
the refrigerant line interconnecting the compressor, the first heat-exchanger, the first expansion valve, and the evaporator is configured to be opened;
the connection line is configured to be closed by the second expansion valve;
a portion of the first line connecting the gas-liquid separator to the fourth expansion valve is configured to be opened by the fourth expansion valve;
a remaining portion of the first line connecting the fourth expansion valve to the compressor is configured to be closed by the fourth expansion valve;
the second line is configured to be opened by the fourth expansion valve;
the first expansion valve is configured to expand the refrigerant introduced through the refrigerant line and supply the refrigerant expanded by the first expansion valve to the evaporator;
the third expansion valve is configured to expand the refrigerant introduced through the refrigerant line and supply the refrigerant expanded by the third expansion valve to the gas-liquid separator through the refrigerant line;
the fourth expansion valve is configured to expand the refrigerant introduced through the first line from the gas-liquid separator and allow the refrigerant expanded by the fourth expansion valve to flow along the second line;
and the gas-liquid separator is configured to supply a gaseous refrigerant among the refrigerant to the compressor through the opened portion of the first line and the second line.

10. The heat pump system of claim 8, wherein, in the second mode:
the refrigerant line interconnecting the compressor, the first heat-exchanger, the first expansion valve, and the evaporator is configured to be opened;
the connection line is configured to be closed by the second expansion valve;
the first line is configured to be opened by the fourth expansion valve;
the second line is configured to be closed by the fourth expansion valve;
the first expansion valve is configured to expand the refrigerant introduced through the refrigerant line and supply the refrigerant expanded by the first expansion valve to the evaporator;
the third expansion valve is configured to expand the refrigerant introduced through the refrigerant line and supply the refrigerant expanded by the third expansion valve to the gas-liquid separator through the refrigerant line;
the fourth expansion valve is configured to allow the refrigerant to flow without expansion introduced through the first line from the gas-liquid separator;
and the gas-liquid separator is configured to supply a gaseous refrigerant among the refrigerant to the compressor through the opened first line.

11. The heat pump system of claim 8, wherein, in the third mode:
the refrigerant line interconnecting the compressor, the first heat-exchanger, the first expansion valve, and the evaporator is configured to be opened;
the connection line is configured to be opened by the second expansion valve;
a portion of the first line connecting the gas-liquid separator to the fourth expansion valve is configured to be opened by the fourth expansion valve;
a remaining portion of the first line connecting the fourth expansion valve to the compressor is configured to be closed by the fourth expansion valve;
the second line is configured to be opened by the fourth expansion valve;
the first expansion valve is configured to expand the refrigerant introduced through the refrigerant line and supply the refrigerant expanded by the first expansion valve to the evaporator;
the second expansion valve is configured to expand the refrigerant introduced through the connection line and supply the refrigerant expanded by the second expansion valve to the chiller;
the third expansion valve is configured to expand the refrigerant introduced through the refrigerant line and supply the refrigerant expanded by the third expansion valve to the gas-liquid separator through the refrigerant line;
the fourth expansion valve is configured to expand the refrigerant introduced through the first line from the gas-liquid separator and allow the refrigerant expanded by the fourth expansion valve to flow along the second line; and
the gas-liquid separator is configured to supply a gaseous refrigerant among the refrigerant to the compressor through the opened portion of the first line and the second line.

12. The heat pump system of claim 8, wherein, in the fourth mode:
a portion of the refrigerant line connecting the compressor, the first heat-exchanger, and the gas injection device is configured to be opened;
a portion of the refrigerant line connecting the gas injection device to the first end of the connection line, and a portion of the refrigerant line connecting the second end of the connection line to the compressor are configured to be opened;
a portion of the refrigerant line connecting the evaporator to the first end of the connection line, and a portion of the refrigerant line connecting the evaporator to the second end of the connection line are configured to be closed by the first expansion valve;
the connection line is configured to be opened by the second expansion valve;
the first line is configured to be opened by the fourth expansion valve;
the second line is configured to be closed by the fourth expansion valve;
the second expansion valve is configured to expand the refrigerant introduced through the connection line and supply the refrigerant expanded by the second expansion valve to the chiller;
the third expansion valve is configured to expand the refrigerant introduced through the refrigerant line and supply the refrigerant expanded by the third expansion valve to the gas-liquid separator through the refrigerant line;
the fourth expansion valve is configured to allow the refrigerant introduced through the first line from the gas-liquid separator to flow without expansion; and
the gas-liquid separator is configured to supply a gaseous refrigerant among the refrigerant to the compressor through the opened first line.

13. The heat pump system of claim 3, wherein:
the second expansion valve and the third expansion valve are 2-way electronic expansion valves configured to selectively expand the refrigerant while controlling the flowing movement of the refrigerant; and
the fourth expansion valve is a 3-way electronic expansion valve configured to selectively expand the refrigerant while controlling the flowing movement of the refrigerant.

14. The heat pump system of claim 1, further comprising:
a second heat-exchanger provided on the refrigerant line between the compressor and the first heat-exchanger; and
an accumulator provided on the refrigerant line between the evaporator and the compressor.

15. The heat pump system of claim 14, wherein:
the first heat-exchanger and the chiller are water-cooled heat-exchangers configured to exchange heat between the refrigerant and a coolant; and
the second heat-exchanger is an air-cooled heat-exchanger configured to exchange heat between the refrigerant and air.

16. The heat pump system of claim 1, further comprising an internal heat-exchanger connected to the refrigerant line connecting the first heat-exchanger and the first expansion valve and connected to the refrigerant line connecting the evaporator and the compressor, the internal heat-exchanger configured to exchange heat between the refrigerant supplied from the first heat-exchanger and the refrigerant supplied from the evaporator.

17. The heat pump system of claim 1, wherein:
the first heat-exchanger is connected to an electrical component through a first coolant line circulating a first coolant; and
a chiller is connected to a battery module through a second coolant line circulating a second coolant.
